(19) United States
(12) Patent Application Publication
(10) Pub. No.: US 2006/0219881 A1
(43) Pub. Date: Oct. 5, 2006

(54) Microscope

(75) Inventors: Rafael Storz, Heidelberg (DE); Holger Birk, Meckesheim (DE); Heinrich Ulrich, Heidelberg (DE); Peter Euteneuer, Lahnau (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems CMS GmbH, Wetzlar (DE)

(21) Appl. No.: 11/358,253

(22) Filed: Feb. 21, 2006

(30) Foreign Application Priority Data
Feb. 22, 2005 (DE) 10 2005 008 197.5

(51) Int. Cl. H01J 5/16

(52) U.S. Cl. 250/234

(57) ABSTRACT

A microscope includes a scanning head including a scanning device for a light beam. A scanning tube lens is coupled to the scanning head. The scanning head may be a scanning head of a scanning microscope. The scanning tube lens may be disposed inside the scanning head. The scanning tube lens may be adapted to an optical requirement of the scanning head.

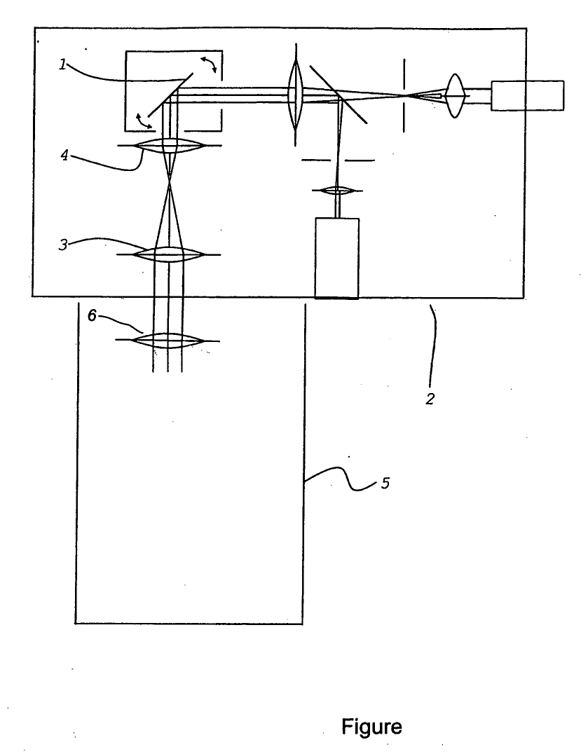

Priority is claimed to the provisional application entitled “Microscope,” filed by applicants on Jan. 13, 2006, and to German patent application DE 10 2005 008 197.5, filed on Feb. 22, 2005, the entire subject matters of both of which are hereby incorporated by reference herein.

The present invention relates to a microscope, in particular a scanning microscope, including a scanning head containing a scanning device for a light beam, and firther including a scanning tube lens.

### BACKGROUND

Microscopes including a scanning head containing a scanning device for a light beam, and further including a scanning tube lens, are known in the field and exist in various forms. The known microscopes have a scanning device for a light beam, which is associated with a scanning head or is accommodated in a scanning head. The scanning head is a modular unit. The known microscopes also have a scanning tube lens by which a light beam controlled by the scanning device is relayed toward the sample to be observed. The scanning tube lens is usually associated with a stand of the microscope.

The known microscopes have the problem that changing the stand, for example, replacing an upright stand with an inverted stand, results in an extensive adjustment of the microscope. This means, on the one hand, high labor cost, and, on the other hand, relatively long periods during which the microscope must be adjusted and during which it can therefore not be used.

### SUMMARY OF THE INVENTION

It is, therefore, an object of the present invention to provide a microscope including a scanning head containing a scanning device for a light beam, and further including a scanning tube lens, which allows for easy adjustment.

The present invention provides a microscope including a scanning head containing a scanning device for a light beam, and further including a scanning tube lens. The scanning tube lens is coupled to the scanning head.

Coupling the scanning tube lens to the scanning head allows the scanning tube lens and the scanning head to be handled as a unit independently of other components. This allows the scanning head and scanning device, on the one hand, and a stand of the microscope, on the other hand, to be manufactured in a modular fashion. These components can be aligned with respect to each other and adjusted (in the infinite beam path) more easily than in the case of an independent scanning tube lens which is not coupled to the scanning head. This makes replacement of the stand, for example, the replacement of an upright stand with an inverted stand, less critical in terms of adjustment.

Thus, the microscope provided in accordance with the present invention is a microscope which allows for particularly easy adjustment.

In an embodiment which is particularly simple in construction and provides for particularly easy adjustment, the scanning tube lens could be disposed in the scanning head. In this manner, a particularly compact unit essentially including the scanning device and the scanning tube lens is achieved within the scope of the scanning head. In this case, the scanning head forms a particularly compact module which can be adjusted relative to a stand in a particularly simple manner.

In other words, the scanning head of the inventive microscope has a scanning tube lens of its own, it being possible for said scanning tube lens to be adapted to the optical requirements of the scanning head in an advantageous manner. For instance, the lens could be designed for UV lighf beams.

Alternatively or additionally, it would be possible for the scanning tube lens to be adapted to the optical requirements of the scanning device. This allows the scanning tube lens to be designed in an uncompromising manner without having to be additionally adapted to other optical requirements.

The microscope could have a second tube lens associated therewith, especially to meet further optical requirements. Such a second tube lens could be adapted, in particular, to the requirements of visual observation. This is beneficial, especially when compared to conventional microscope designs, in which a shared tube lens is used for the scanning requirements and for the requirements of visual observation. In this known case, it is mostly necessary to make a compromise with respect to the optical requirements.

### BRIEF DESCRIPTION OF THE DRAWING

The teaching of the present invention can be embodied and refined in different ways. The present invention is elaborated upon below based on an exemplary embodiment with reference to the drawing.

The only Figure is a schematic view of an exemplary embodiment of a microscope according to the present invention.

### DETAILED DESCRIPTION

The only Figure schematically shows an exemplary embodiment of a microscope according to the present invention. The microscope has a scanning device 1 for a light beam and a scanning head 2. With a view to particularly easy adjustment, scanning tube lens 3 is coupled to scanning head 2, said scanning tube lens 3 being disposed inside the scanning head 2. Also disposed in scanning head 2 is a scanning eyepiece 4. In the exemplary embodiment shown, the adjustment of scanning head 2 relative to a stand 5 is simplified because scanning tube lens 3 and scanning head 2 together form a common module. This module is adjustable relative to stand 5.

In the exemplary embodiment shown, scanning tube lens 3 can be advantageously adapted to the optical requirements of scanning head 2 and/or of scanning device 1.

Stand 5 has associated therewith other optical components. For example, a second tube lens 6, which may be adapted to the requirements of visual observation, could be associated with the microscope and, specifically, with stand 5.

An adjustment of scanning head 2 relative to stand 5 could be accomplished by tilting the two modules relative to each other. In the process, the optical system could be set to infinity. In other words, the modules can be particularly easily adjusted in the infinite beam path of the objective lens of the microscope. In this connection, an infinite beam path could exist with respect to the pupil.

With regard to further advantageous embodiments of the microscope according to the present invention and to avoid repetitions, reference is made to the general part of the description and to the appended claims.

Finally, it should be particularly noted that the exemplary embodiment described above serves merely for discussion of the claimed teaching without limiting it to this exemplary embodiment.

What is claimed is:

1. A microscope comprising:
a scanning head including a scanning device for a light beam; and
a scanning tube lens coupled to the scanning head.

2. The microscope as recited in claim 1 wherein the scanning head is a scanning head of a scanning microscope.

3. The microscope as recited in claim 1 wherein the scanning tube lens is disposed inside the scanning head.

4. The microscope as recited in claim 1 wherein the scanning tube lens is adapted to at least one optical requirement of the scanning head.

5. The microscope as recited in claim 3 wherein the scanning tube lens is adapted to at least one optical requirement of the scanning head.

6. The microscope as recited in claim 1 wherein the scanning tube lens is adapted to at least one optical requirement of the scanning device.

7. The microscope as recited in claim 3 wherein the scanning tube lens is adapted to at least one optical requirement of the scanning device.

8. The microscope as recited in claim 4 wherein the scanning tube lens is adapted to at least one optical requirement of the scanning device.

9. The microscope as recited in claim 1 further comprising a second tube lens.

10. The microscope as recited in claim 3 further comprising a second tube lens.

11. The microscope as recited in claim 4 further comprising a second tube lens.

12. The microscope as recited in claim 6 further comprising a second tube lens.

13. The microscope as recited in claim 9 wherein the second tube lens is adapted to at least one requirement of visual observation

14. The microscope as recited in claim 10 wherein the second tube lens is adapted to at least one requirement of visual observation.

15. The microscope as recited in claim 11 wherein the second tube lens is adapted to at least one requirement of visual observation.

16. The microscope as recited in claim 12 wherein the second tube lens is adapted to at least one requirement of visual observation.
